(19) United States
(12) Patent Application Publication
(10) Pub. No.: US 2006/0169125 A1
(43) Pub. Date: Aug. 3, 2006

(54) Musical pacemaker for physical workout

(76) Inventors: Rafael Ashkenazi, Tel Aviv (IL); Dekel Tzidon, Hod Hasharon (IL)

Correspondence Address: PEARL COHEN ZEDEK, LLP, 1500 BROADWAY 12TH FLOOR, NEW YORK, NY, 10036, US

(21) Appl. No.: 11/328,203

(22) Filed: Jan. 10, 2006

Related U.S. Application Data
(60) Provisional application No. 60/642,144, filed on Jan. 10, 2005.

(51) Int. Cl. G10H 7/00

(52) U.S. Cl. 84/612

(57) ABSTRACT

A music player device comprising a playback device for playing music piece, a memory unit for storing a database comprising a list of rhythm values attributed to each music piece corresponding to the rhythm of that piece; and a controller for choosing a workout program comprising at least one of a series of workout sessions each selected to match a desired rhythm and playing at least one of a series of music pieces, that are selected by their rhythm value, to correspond to the desired rhythm of the workout sessions.

### CROSS-REFERENCE TO RELATED APPLICATIONS

This application claims the benefit of U.S. Provisional Patent Application No. 60/642,144, filed Jan. 10, 2005, which is hereby incorporated by reference.

### FIELD OF THE INVENTION

The present invention relates to a music player with beat control. More particularly the present invention relates to device and method for enhancing physical workout of a trainee performed to the sound of musical pieces.

### BACKGROUND OF THE INVENTION

Rhythm, besides being the essence of music, can give music its mood and temperament. Different rhythms are associated with different moods and states of mind. Rhythm synchronizes social activities such as dancing (be it ballet or disco), marching on parades, performing in ceremonies or in funerals. For some years rhythmic music is strongly associated with physical exercise and fitness training. In many such activities, and typically in fitness training (especially those involved in increasing the heartbeat rate in order to improve cardiovascular fitness, such as jogging, cycling, spinning, and other aerobic training) the rhythm of the music played to the trainees is aimed at pushing the trainees to train under substantially accelerated heartbeat.

In U.S. Pat. No. 5,533,947 (Tomlinson et al.) an apparatus for emitting pre-programmed songs at a pre-determined tempo or a selectable tempo of either one or two beats per rotation of a jump-rope is disclosed. The apparatus comprises a rope or like material, contained at each end by a handle. One handle includes an electrical circuit integrally contained within. The electrical circuit includes a storage means for storing ten or more songs, a sensing means for correlating the rotation of the rope with the emission of musical notes, an annunciator means to produce the notes, an external switch to select or deselect power to the circuit, a switch to select the desired tempo of the pre-programmed songs and a switch to select a particular song from the series of preprogrammed songs.

U.S. Pat. No. 5,137,503 (Yeh) disclosed an exercise hand grip having sound-reproducing means and application of such hand grip that comprises mainly two handles and one connection rod. One of the handles comprises a first housing and a second housing, both of which are of hollow constructions made of plastic material by means of injection molding. The first housing is provided therein with a speaker mount with a circular speaker disposed thereon, a sound-reproducing apparatus provided therein with conductive pieces disposed in the battery mount, and a circuit plate in contact with batteries lodged in the battery mount. The circuit plate comprises thereon an integrated circuit storing programmably musical melodies or commands. The second housing is symmetrical in shape with the first housing. Another handle is provided with a third housing and a fourth housing, both of which are of hollow constructions made of plastic material by means of injection molding. The third housing is provided therein with an exercise count display apparatus. The connection rod is of a bendable spring body coupled pivotally at both ends thereof with both handles.

In U.S. Pat. No. 5,137,488 (Yeh) there was disclosed a sports rod equipped with sound reproducer that is composed mainly of a first rod case and a second rod case, both being of hollow construction and made of plastic material by injection molding. The first and the second rod cases join to form a rod-shaped body with the central portion thereof being hand grip and with both ends thereof being circularly headed. The sports rod has therein a sound reproducer, which in turn is provided with a speaker mounted on the speaker mount, and a circuit board containing thereon an integrated circuit with music or exercise commands stored programmably therein. When the switch of the sports rod is turned on, the sound reproducing device of the sports rod begins producing the sound of music or exercise commands stored in the integrated circuit thereof.

These devices are characterized as playing music to accompany physical exercises or sport activities. The rotation of the rope in Tomlinson's patent controls the music tempo.

### SUMMARY OF THE INVENTION

It is a purpose of the present invention to provide device and method for enhancing physical workout of a trainee performed to the sound of musical pieces, where the rhythm of the music (the “beat”) is selected or adjusted (or both) to match the required pace of the exercise or the desired heartbeat of the trainees.

There is thus provided, in accordance with some preferred embodiments of the present invention, a method for enhancing physical workout of a trainee performed to the sound of musical piece, the method comprising choosing a workout program comprising at least one of a series of workout sessions each selected to match a desired rhythm and playing at least one of a series of musical pieces, that are selected by their rhythm value, to correspond to the desired rhythm of said at least one of a series of workout sessions.

Furthermore, in accordance with some preferred embodiments of the present invention, the desired rhythm for each workout session is related to the rhythm of the heartbeat of the trainee.

Furthermore, in accordance with some preferred embodiments of the present invention, the desired rhythm for each workout session is related to the rhythm of the desired step pace of the trainee.

Furthermore, in accordance with some preferred embodiments of the present invention, the method further comprises creating a play list of all musical pieces that their rhythm value matches to the desired rhythm of said at least one of a series of workout sessions.

Furthermore, in accordance with some preferred embodiments of the present invention, the desired rhythm is selected based on measuring a physical parameter relating to a current condition of the trainee.

Furthermore, in accordance with some preferred embodiments of the present invention, the physical parameter comprises a measured parameter selected from a group of parameters including: heartbeat, blood pressure, blood oxygen level, breathing rate, walking or running pace, step.

Furthermore, in accordance with some preferred embodiments of the present invention, the method further comprises sampling the musical pieces to determine their rhythm values.

Furthermore, in accordance with some preferred embodiments of the present invention, a workout program is selected from a list of predefined workout programs.

Furthermore, in accordance with some preferred embodiments of the present invention, the desired rhythm is manually set by the trainee.

Furthermore, in accordance with some preferred embodiments of the present invention, the method further comprises changing the rhythm of said at least one of a series of musical pieces to match one or more desired workout rhythms.

Furthermore, in accordance with some preferred embodiments of the present invention, the method further comprises adding a synthetic beat to said at least one of a series of musical pieces.

Furthermore, in accordance with some preferred embodiments of the present invention, the synthetic beat comprises sound selected from a group of sounds including: hands clapping, drums, heartbeat and metronome.

Furthermore, in accordance with some preferred embodiments of the present invention, there is provided a method for enhancing physical workout of a trainee performed to the sound of musical piece, the method comprising setting desired rhythm for workout rhythm; and playing a musical piece that matches the desired rhythm.

Furthermore, in accordance with some preferred embodiments of the present invention, there is provided a software program designed to build a musical database comprising attributing each of the musical works a rhythm value corresponding to the rhythm of that piece.

Furthermore, in accordance with some preferred embodiments of the present invention, there is provided a music player device comprising a playback device for playing music piece; a memory unit for storing a database comprising a list of rhythm values attributed to each music piece corresponding to the rhythm of that piece; and a controller for choosing a workout program comprising at least one of a series of workout sessions each selected to match a desired rhythm and playing at least one of a series of music pieces, that are selected by their rhythm value, to correspond to the desired rhythm of said at least one of a series of workout sessions.

Furthermore, in accordance with some preferred embodiments of the present invention, the controller includes a control function that enable the player to adjust the music speed to one or more desired rhythms.

Furthermore, in accordance with some preferred embodiments of the present invention, the controller is further adapted to set the desired rhythm for each workout session related to the heartbeat of the trainee for each workout session.

Furthermore, in accordance with some preferred embodiments of the present invention, the controller is further adapted to set the desired rhythm for each workout session related to the desired step pace of the trainee for each workout session.

Furthermore, in accordance with some preferred embodiments of the present invention, the database includes a play list of all musical works that their rhythm value matches to the desired rhythm of said at least one of a series of workout sessions.

Furthermore, in accordance with some preferred embodiments of the present invention, the device is further provided with a sensor for sensing a physical parameter relating to a current condition of the trainee, so as to facilitate selecting the desired rhythm based on the physical parameter.

Furthermore, in accordance with some preferred embodiments of the present invention, the sensor comprises a sensor for measuring a parameter selected from a group of parameters including: heartbeat, blood pressure, blood oxygen level, breathing rate, walking or running pace, step.

Furthermore, in accordance with some preferred embodiments of the present invention, the device further comprises a sampler for sampling the musical pieces to determine their rhythm values.

Furthermore, in accordance with some preferred embodiments of the present invention, the device is further provided with an adjustment control for adjusting the desired rhythm.

Furthermore, in accordance with some preferred embodiments of the present invention, the device is further provided with a synthetic beat generator.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates main stages for playing a musical piece whose rhythm is suitable for a particular activity, according to a preferred embodiment of the present invention.

FIG. 2 illustrates in more details stages of setting desired rhythm suitable for a particular activity, based on physical parameters measured on the trainee or on manual input, according to a preferred embodiment of the present invention.

FIG. 3 illustrates stages in providing a play list of musical pieces whose rhythms is suitable for a particular activity, and playing it in a desired order reflecting a desired workout program, according to a preferred embodiment of the present invention.

FIG. 4 illustrates in a block diagram adjustment of music beat to a desired rate, according to a preferred embodiment of the present invention.

FIG. 5 illustrates in block diagram a device for enhancing physical workout of a trainee performed to the sound of musical pieces, according to a preferred embodiment of the present invention.

FIG. 6 is a flow chart demonstrating a method for enhancing physical workout of a trainee performed to the sound of musical pieces, according to a preferred embodiment of the present invention.

FIG. 7 illustrates in a block diagram adding synthetic beat to the played musical pieces of the play list, according to a preferred embodiment of the present invention.

### DETAILED DESCRIPTION OF PREFERRED EMBODIMENTS

The present invention is aimed at providing device and method for enhancing physical workout of a trainee performed to the sound of musical pieces, where the rhythm of the music (the “beat”) matches the required pace of the exercise or the desired heartbeat of the trainees.

An aspect of the present invention is the realization that many fitness training programs involve one or more stages of training to rhythmic music, where the rhythm is required to match the workout pace of the trainees, or match a desired heartbeat rate.

Another aspect of the present invention is the ability to change the beat of a musical piece with minimal influence on the sound of it. This will allow more musical pieces to comply with the “desired beat” by adjusting the actual beat to the desired one.

Accordingly, the present invention brings a novel approach to training music. According to a preferred embodiment of the present invention, it is suggested to compile a play list of musical pieces that are matched the listeners' (or the compiler's) taste and are intended to be played to the trainees (throughout the present invention when mentioning trainees it is generally also intended to include a single trainee).

In one preferred embodiment of the present invention the play list may include musical pieces whose rhythm is known, so that these musical pieces may be played according to the required exercise rhythm program. This allows the trainer to control the pace of the trainees.

Additionally, or alternately, in some preferred embodiments of the present invention, an approach is to allow the trainer to set a training program by selecting musical pieces whose rhythm matches the program. In some embodiments, each musical piece may be assigned an indication indicating its beat, and a database of all musical pieces and their corresponding beats may be formed. When a specific workout program is chosen, a processor may be used to choose musical pieces whose beats match the desired workout program beats.

Another aspect of the present invention is the provision of a music player that incorporates such database and processor.

Yet another preferred embodiment of the present invention is a music player that comprises, apart from the music playback components and the processor and database mentioned hereinabove, a sampling device for sampling of physical parameters of the trainee, for example at least one of heartbeat, blood pressure, blood oxygen level, breathing rate, walking or running pace, step, so that the processor can choose music pieces that are suitable for that measured parameter, or that are aimed at changing the measurement (either slowing down or gaining pace). The desired rhythm of the selected musical pieces may be same as or close to the values of the measured parameters, they may be multiples or quotients of these values, or any other values that relate to the measured parameters, as rendered fit and proper for the planned workout session.

A personal rhythm is an important factor for training efficiency. Keeping the correct training rhythm throughout the workout exercise greatly improves training results. Playing to each trainee musical playback in his own desired rhythm allows him to keep up with the exercise pace.

A typical workout program may consist of a 10 minute session carried out with music at 100 beats per minute (BPM) for warm up, followed by 20 minutes of 130 BPM (strain), then 2 minutes of 150 BPM (sprint) and finally 10 minutes of 100 BPM to cool down.

The personal rhythm of a jogger is defined by the walking speed (derived, for example, from personal parameters such as age, stamina, gender, etc.) and step length (derived, for example, from height, personality, etc.). For a trainee who wishes to keep a walking speed of 5 km/h at an average step of 0.65 meter the desired BPM value may be derived from the relation:
Desired BPM=speed/step length=5000/(60*0.65)=128 BPM

The personal beat can be set for each step, as well as for a number of steps.

Assuming that it is difficult to find the exact BPM value of many songs and music pieces, as acceptable range of tolerance can optionally be defined allowing the processor to chose a musical piece within a range instead of finding a musical piece whose BPM exactly matches the desired BPM.

In an alternative embodiment of the present invention a musical piece maybe chosen and then the beat of that piece changed to the desired beat rate with limited effect on the original musical piece allowing the trainee to keep the desired workout beat accurate. This ability is known in the art, and included, for example, in WINAMP software from NullSoft as well as many other DJ software programs that may use Fourier transformations or fast Fourier transformations to achieve the desired effect.

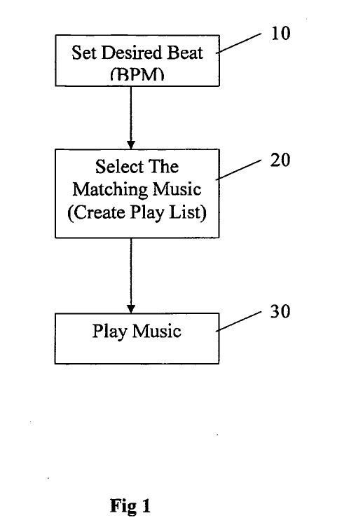

FIG. 1 illustrates stages in finding a musical piece from a play list whose rhythm is suitable for a particular activity and playing it, according to a preferred embodiment of the present invention. The trainee (or his trainer, or a predetermined workout program) sets (10) the desired BPM for the musical playback according to the rhythm of the exercise. The exercise rhythm is chosen to gain maximum training efficiency while maintaining a safe level of heartbeat.

The processor selects (20) musical pieces that match the desired BPM (either exactly or within an allowed range) to form a play list, and then the music player plays (30) the musical pieces on the play list so as to keep the trainee at the desired pace throughout his exercise. In one alternative embodiment the play list includes musical pieces that exactly match the rhythms desired for a particular workout session. In another alternative embodiment of the present invention the rhythms of some or all the musical pieces on the play list is adjusted to match the desired rhythms for the planned workout session.

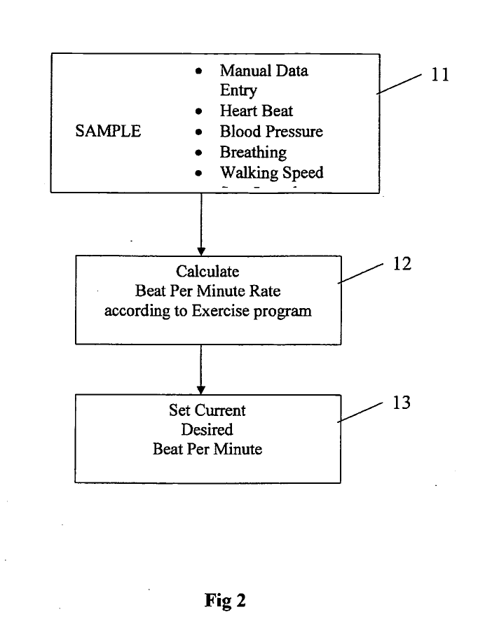

FIG. 2 illustrates in more details the stages of setting the desired rhythm suitable for a particular activity, based on physical parameters measured on the trainee or on manual input, according to a preferred embodiment of the present invention. In some preferred embodiments of the present invention the input is sampled (11) physical parameters. In other embodiments manual input of desired BPM is facilitated.

The processor then calculates (12) the desired BMP. It may be a direct result (in case of manual input), a simple reference table or a function such as:
BPM=k*heartbeat

Or it may calculate the desired BPM using a more complex formula, such as BPM=f(heartbeat, exercise duration, age, stamina, etc.).

In addition the sampled parameters may be used as a limiter that force the BPM to decrease when reaching the limit of the specific physical parameter for example reaching the maximum heartbeat allowed.

Setting the calculated BPM (13) and making it available for the controller to select the matching musical pieces (20) to create the play list.

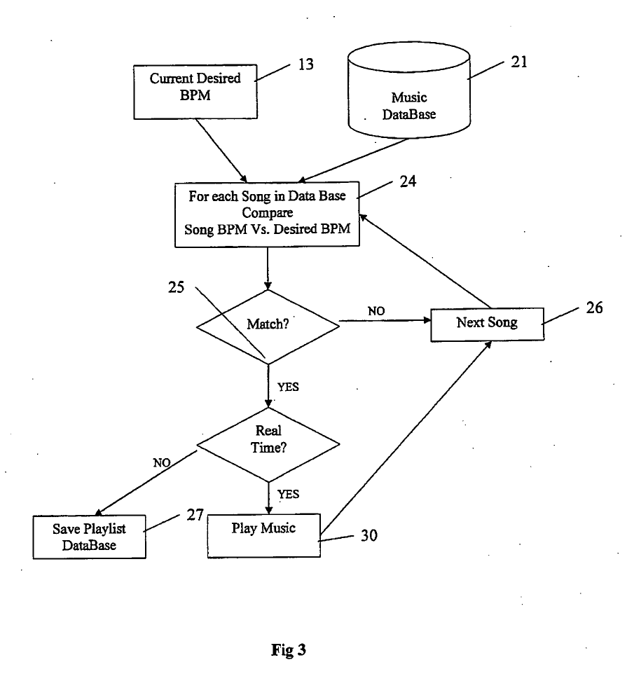

FIG. 3 illustrates stages in providing a play list of musical pieces whose rhythms is suitable for a particular activity and playing it in a desired order reflecting a desired workout program, according to a preferred embodiment of the present invention. After the desired BPM is determined (13) it is checked (24) against the music pieces available on the database (21) to find musical pieces with matching BPM. All (or at least some) musical pieces are checked for matching (25) and these pieces that do not meet the desired criterion of BPM are neglected (26) whereas the musical pieces that match the BPM are checked for their duration. If the duration is acceptable that piece is played (30). Otherwise it is set aside (possibly for later playing) and saved (27) on a play list. This process of building the play lists according to some preferred BPM ratings may be performed offline, either by the player controller or by separate computer, for faster implementation.

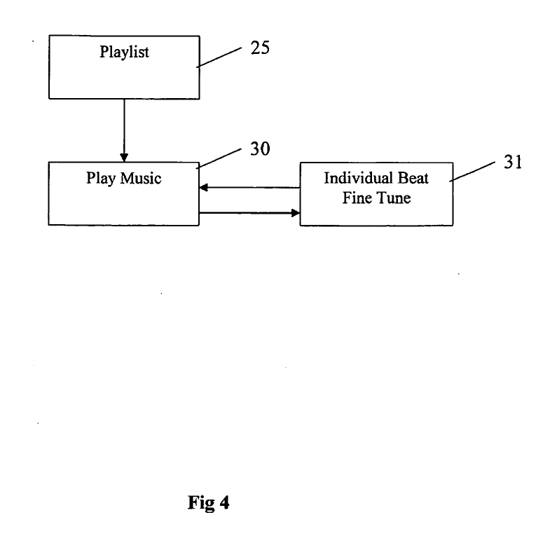

FIG. 4 illustrates in a block diagram adjustment of music beat to a desired rate, according to a preferred embodiment of the present invention. Batch of songs or music pieces (25) either preselected (on play list 27) or chosen in real time, with same BPM (24) or in an acceptable range of BPMs is fed to the music played (30), with the capability of using a provided control for fine-tuning to individual beat (31).

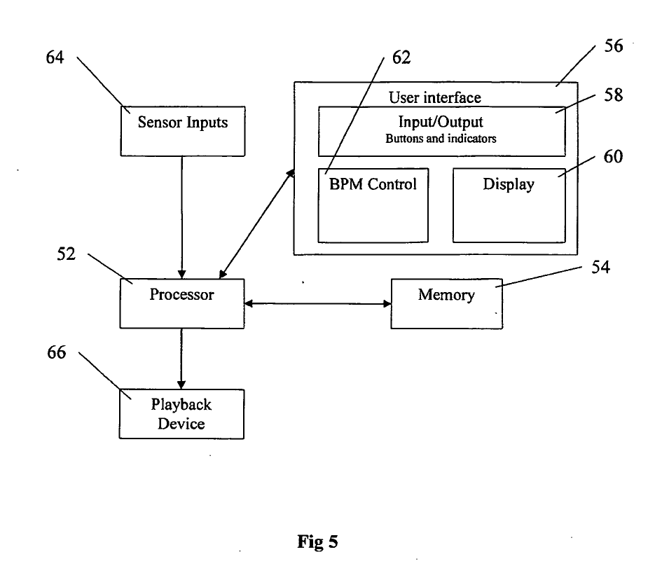

FIG. 5 illustrates in block diagram a device for enhancing physical workout of a trainee performed to the sound of musical pieces, according to a preferred embodiment of the present invention. It generally comprises a processor (52) and memory (54) for storing the musical pieces and indications of each piece's BPM (and possibly for storing the play list). In a preferred embodiment of the present invention the device also includes user interface (56) for receiving input on the desired workout session such as a series of BPM values and duration. The user interface may include control buttons and indicators (58), display (60) and BMP control (62). It may also include sensor input means (64) for receiving input from sensors measuring physical parameters such as heartbeat, blood pressure, pace step, and other parameters of the trainee. The processor is linked to a playback device (66) for playing the selected musical pieces.

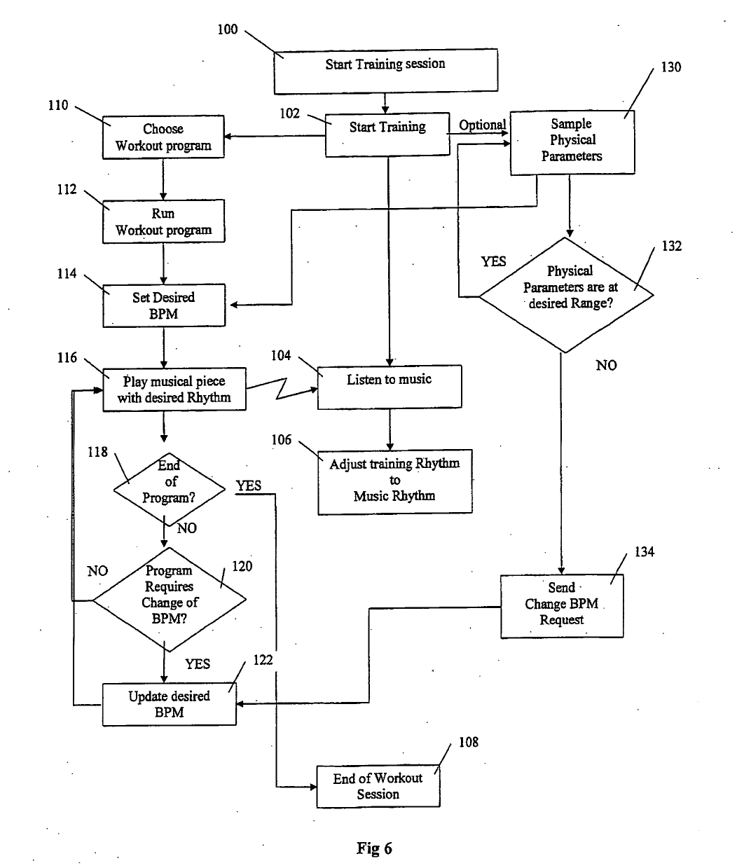

FIG. 6 is a flow chart demonstrating a method for enhancing physical workout of a trainee performed to the sound of musical pieces, according to a preferred embodiment of the present invention. A main process is described, where a trainee engages in a physical workout session 102 while listening to music 104, allowing the music rhythm to guide him and set the pace of the workout session 106. When the rhythm of the music increases so does the workout pace, and when the music rhythm decreases so does the workout pace. Finally the music stops ending the workout session 108. A parallel process commences with the trainee's decision to start his workout session. He chooses a particular workout program 110 that dictates a play-list of musical pieces. The program starts running 112, a first workout tempo is chosen 114 and music is played 116. As the workout program involves changes in tempo, so does the music rhythm changes, thus notifying the trainee of the required change in the workout tempo (arrow between 116 and 104). The workout tempo changes according to the chosen workout program (118 to 108) until it ends, reaching tempo zero, thus stopping the music. Parallel to these processes an additional optional process may be activated, monitoring physical parameters of the trainee 130, so as to use these parameters online for updating the music tempo 114, to enhance the workout program and adjust it personally to the trainee's own needs. The measured parameters may also be used for safety control, preventing the trainee from exceeding thresholds 132 that may jeopardize his health or wellbeing, and change the tempo of the workout session (by changing the music tempo—134) thus slowing down the trainee's workout pace.

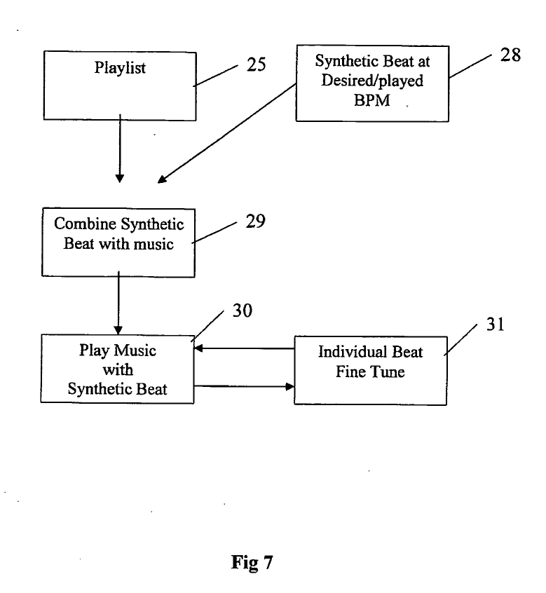

FIG. 7 illustrates in a block diagram adding synthetic beat 29 to the played musical pieces of the play list, according to a preferred embodiment of the present invention. This is an additional optional feature that is aimed at aiding trainees lacking a sense of rhythm, or enhancing the tempo of the musical pieces. In some preferred embodiments hand clapping, drum beat or metronome sound may simulated—all in order to help the trainee recognize the tempo and train in the right pace.

A main advantage of the present invention lies in the fact that contrary to the patents mentioned hereinabove (in the background section of the present specification), where the tempo of the workout of the trainee sets the tempo of the music, in the present invention the tempo of the music is predetermined to dictate to the trainee the correct pace at which he is to train, according to the chosen workout plan and consequent play-list.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for enhancing physical workout of a trainee performed to the sound of musical piece, the method comprising:
choosing a workout program comprising at least one of a series of workout sessions each selected to match a desired rhythm; and
playing at least one of a series of musical pieces, that are selected by their rhythm value, to correspond to the desired rhythm of said at least one of a series of workout sessions.

2. The method of claim 1, wherein the desired rhythm for each workout session is related to the rhythm of the heartbeat of the trainee.

3. The method of claim 1, wherein the desired rhythm for each workout session is related to the rhythm of the desired step pace of the trainee.

4. The method of claim 1, further comprising creating a play list of all musical pieces that their rhythm value matches to the desired rhythm of said at least one of a series of workout sessions.

5. The method of claim 1, wherein the desired rhythm is selected based on measuring a physical parameter relating to a current condition of the trainee.

6. The method of claim 5, wherein the physical parameter comprises a measured parameter selected from a group of parameters including: heartbeat, blood pressure, blood oxygen level, breathing rate, walking or running pace, step.

7. The method of claim 1, further comprising sampling the musical pieces to determine their rhythm values.

8. The method of claim 1, wherein a workout program is selected from a list of predefined workout programs.

9. The method of claim 1, wherein the desired rhythm is manually set by the trainee.

10. The method of claim 1, further comprising changing the rhythm of said at least one of a series of musical pieces to match one or more desired workout rhythms.

11. The method of claim 1 further comprising adding a synthetic beat to said at least one of a series of musical pieces.

12. The method of claim 11, wherein the synthetic beat comprises sound selected from a group of sounds including: hands clapping, drums, heartbeat and metronome.

13. A method for enhancing physical workout of a trainee performed to the sound of musical piece, the method comprising:
setting a desired rhythm for workout rhythm; and
playing a musical piece that matches the desired rhythm.

14. A software program designed to build a musical database comprising:
attributing each of the musical works a rhythm value corresponding to the rhythm of that piece

15. A music player device comprising:
a playback device for playing music piece;
a memory unit for storing a database comprising a list of rhythm values attributed to each music piece corresponding to the rhythm of that piece; and
a controller for choosing a workout program comprising at least one of a series of workout sessions each selected to match a desired rhythm and playing at least one of a series of music pieces, that are selected by their rhythm value, to correspond to the desired rhythm of said at least one of a series of workout sessions.

16. The device as claimed in claim 15, wherein the controller includes a control function that enable the player to adjust the music speed to one or more desired rhythms.

17. The device of claim 15, wherein the controller is further adapted to set the desired rhythm for each workout session related to the heartbeat of the trainee for each workout session.

18. The device of claim 15, wherein the controller is further adapted to set the desired rhythm for each workout session related to the desired step pace of the trainee for each workout session.

19. The device of claim 15, wherein the database includes a play list of all musical works that their rhythm value matches to the desired rhythm of said at least one of a series of workout sessions.

20. The device of claim 15, further provided with a sensor for sensing a physical parameter relating to a current condition of the trainee, so as to facilitate selecting the desired rhythm based on the physical parameter.

21. The device of claim 20, wherein the sensor comprises a sensor for measuring a parameter selected from a group of parameters including: heartbeat, blood pressure, blood oxygen level, breathing rate, walking or running pace, step.

22. The device of claim 15, further comprising a sampler for sampling the musical pieces to determine their rhythm values.

23. The device of claim 15, further provided with an adjustment control for adjusting the desired rhythm.

24. The device of claim 15, further provided with a synthetic beat generator.
